(19) United States
(12) Patent Application Publication
(10) Pub. No.: US 2007/0003092 A1
(43) Pub. Date: Jan. 4, 2007

(54) Hat structure with earphones

(75) Inventor: Ching-Chao Shen, Taipei (TW)

Correspondence Address: TROXELL LAW OFFICE PLLC, SUITE 1404, 5205 LEESBURG PIKE, FALLS CHURCH, VA, 22041, US

(73) Assignee: Hope Land Enterprise Co., Ltd.

(21) Appl. No.: 11/445,316

(22) Filed: Jun. 2, 2006

(30) Foreign Application Priority Data
Jun. 29, 2005 (TW) 094210926

(51) Int. Cl. H04R 25/00

(52) U.S. Cl. 381/374

(57) ABSTRACT

A hat structure with earphones, including a hat body able to cover the ears and earphones, and which is characterized in that: fixing pieces are respectively stitched to two sides of the hat body close to position of the ears, and earphone fixing jackets are used to fixedly clamp the fixing pieces, thereby achieving the objective of fixing the structural configuration. Moreover, earphones are installed within the earphone fixing jackets. Accordingly, the earphones can be connected to various sound players, whereafter the hat body is placed on the head, thereby completely covering the ears and reducing the affect on listening quality from external wind noise or general noise. Hence, the present invention is not only an invention with aesthetic appeal, but is also provided with novelty features.

### BACKGROUND OF THE INVENTION

(a) Field of the Invention

The present invention relates to an improved hat structure with earphones, and more particularly to a hat with earphones that is able to connect to various sound players, and which completely covers the ears in order to reduce the effect on listening quality from external wind noise or general noise.

(b) Description of the Prior Art

In general, the various sound players in the current market must be used in conjunction with appropriate speakers or earphones in order to output the sound or speech signals from the sound player. However, listening quality is often affected by external wind noise or general noise regardless of whether the user is moving or stationary when listening to the player, and this causes inconvenience in use. Hence, there is a need for improvement, and as such, in order to meet the needs of the market, the inventor of the present invention has particularly designed a hat structure with earphones, wherein appropriate fixing pieces are fitted to a hat body to secure earphone fixing jackets using a clip method, and various types of earphones can be installed within the earphone fixing jackets. Moreover, the present invention is suitable for use in various hat bodies having the further function to keep the head and ears warm, such as wool hats, knitted hats, cloth hats, and so on, wherein the hat body must completely cover the ears, thereby not only providing a warming function, but also the function to listen to sound or speech signals from various sound players. Furthermore, the earphones will not easily come away from the hat body after fixing in place, and external design of the earphone fixing jackets can be changed according to the different hat bodies fashionable in the market at the time. Moreover, the earphone fixing jackets are designed so as to form an integral body with the hat, thereby not only enhancing aesthetic appeal, but also preventing the present invention from losing its novelty features due to changes in fashion.

### SUMMARY OF THE INVENTION

In light of the shortcomings of the aforementioned prior art structure, the inventor of the present invention, having accumulated years of experience in related arts, attentively and circumspectly carried out extensive study and exploration to ultimately design a new improved hat structure with earphones.

A primary objective of the present invention is to provide a hat structure installed with earphones, wherewith the ears are completely covered after placing the hat on the head, thereby reducing the effect on listening quality from external wind noise or general noise, and which not only enhances aesthetic appeal, but also the novelty feature of the present invention.

In order to achieve the aforementioned objective, a hat structure with earphones of the present invention is primarily structured to comprise a hat body that covers the ears and earphones, wherein fixing pieces are of annular form, outer periphery of each of which is fixedly stitched to two sides of the hat body corresponding to position of the ears. Moreover, earphones are respectively installed within earphone fixing jackets, and a fixing ring is disposed in an opening of each of the earphone fixing jackets. When assembling, the fixing rings are first respectively disposed within the fixing pieces, and then joined to the earphone fixing jackets, thereby clamping the fixing pieces by means of the fixing rings and the earphone fixing jackets, and achieving the objective of fixing the structural configuration.

According to the aforementioned structure, because the hat body is provided with functionality to keep the head and ears warm, thus, the hat body must completely cover the ears. Hence, when in use, effect on listening quality from external wind noise or general noise is substantially reduced. In addition, the earphone fixing jackets are respectively fixed to each periphery of the fixing pieces, which not only facilitates assembly thereof, but also enables the fixing pieces to be stitched to the hat body to form an integral body therewith, thereby avoiding presenting the hat body with a matchless effect and enhancing its aesthetic appeal. Moreover, the earphone fixing jackets can be varied to match the design of different hat bodies, thereby increasing novelty of the present invention.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an exploded elevational view according to the present invention.

FIG. 2 shows an assembled elevational view according to the present invention.

FIG. 3 shows a cross-sectional view according to the present invention.

FIG. 4 shows a schematic view of an embodiment in use according to the present invention.

### DETAILED DESCRIPTION OF THE PREFERRED EMBODIMENTS

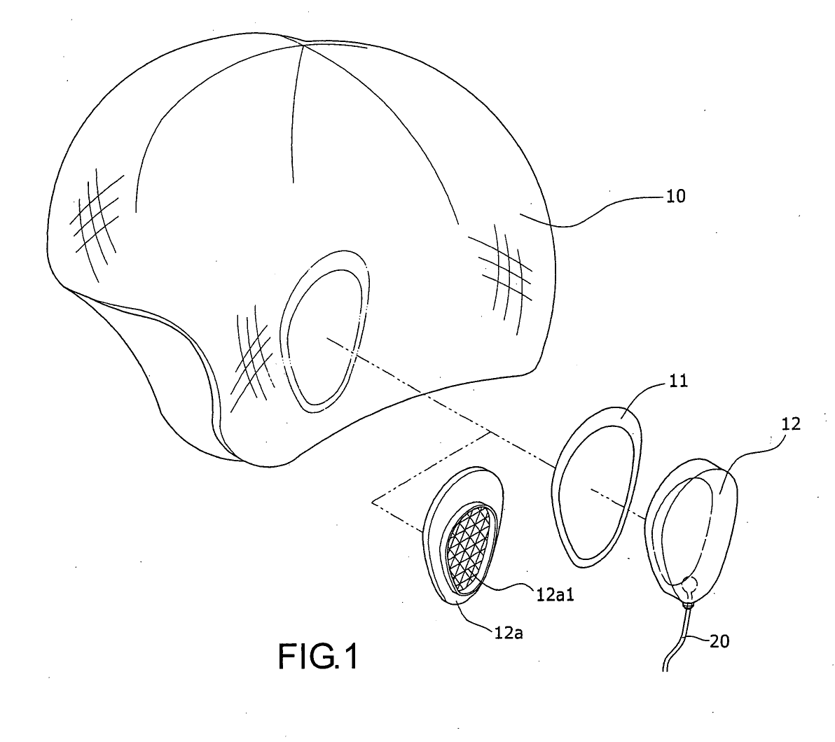

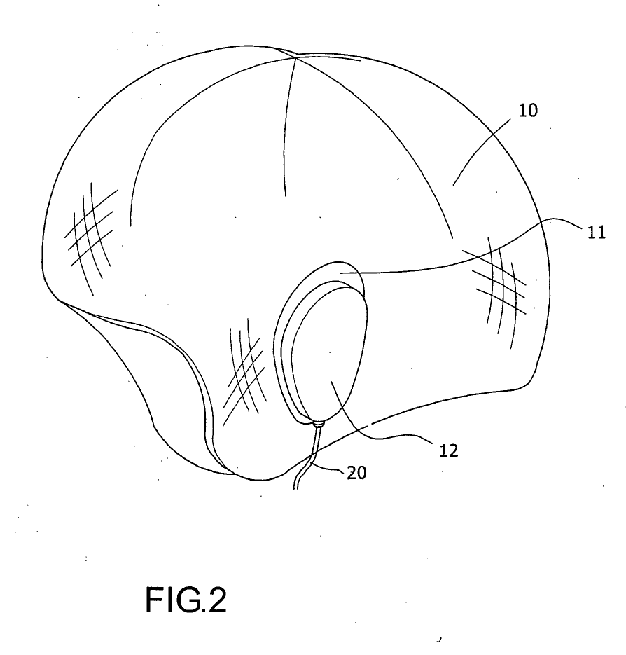

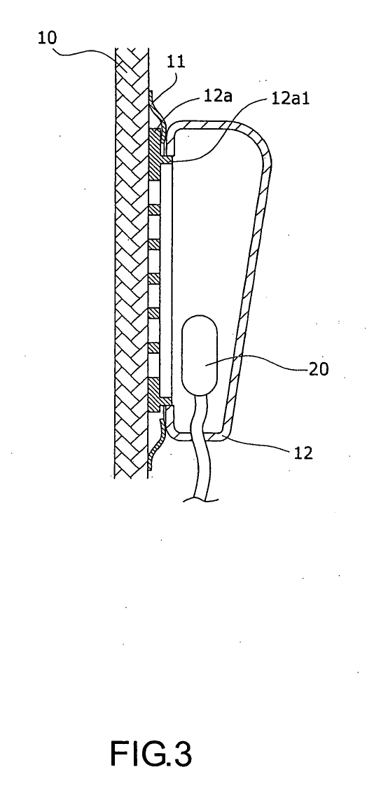

Referring to FIGS. 1, 2 and 3, which show an improved hat structure with earphones of the present invention, primarily structured to comprise a hat body 10 that covers the ears and earphones 20, wherein:

Two fixing pieces 11 are respectively fixed to both sides of the hat body 10 corresponding to position of the ears. Each of the fixing pieces 11 are of annular form, outer periphery of which is fixedly stitched to the hat body 10. Moreover, the earphones 20 are respectively installed within earphone fixing jackets 12, and a fixing ring 12a is disposed in an opening of each of the earphone fixing jackets 12. When assembling, the fixing rings 12a are first respectively disposed within the fixing pieces 11, thereby causing clasp portions 12a1 within each of the fixing rings 12a to protrude out from circular holes defined in the center of fixing piece 11, thereafter, the fixing rings 12a are respectively fixedly clipped to a respective inner edge of the opening of the earphone fixing jackets 12, thereby clamping the fixing pieces 11 by means of the fixing rings 12a and the earphone fixing jackets 12, and achieving the objective of fixing the structural configuration.

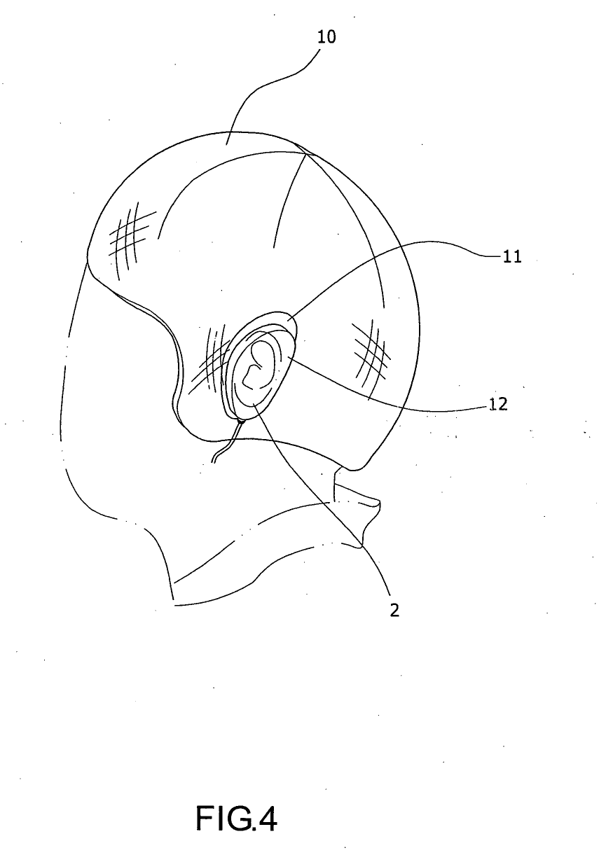

Referring to FIG. 4, which shows a schematic view of an embodiment of the present invention in use, wherein the hat body 10 is placed on the head of a user, and position of the fixing pieces 11 are respectively aligned with ears 2 of the user, meanwhile, the earphone fixing jackets 12 are able to completely cover the ears 2, thereby achieving the objective of substantially reducing the effect on listening quality from external wind noise or general noise.

In conclusion, the improved hat structure with earphones of the present invention uses the earphone fixing jackets 12 to fixedly clamp the fixing pieces 11, which are stitched to appropriate positions on the hat body 10, thereby enabling the ears to be completely covered after placing the hat body 10 on the head, which substantially reduces the effect on listening quality from external wind noise or general noise. The present invention is not only an invention with aesthetic appeal, but is also provided with novelty features. Furthermore, practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A hat structure with earphones, comprising a hat body able to cover the ears and earphones, and is characterized in that: fixing pieces are respectively stitched to two sides of the hat body close to position of the ears, and earphone fixing jackets are used to fixedly clamp the fixing pieces, thereby achieving the objective of fixing the structural configuration, moreover, earphones are installed within the earphone fixing jackets.

2. The hat structure with earphones according to claim 1, wherein the fixing pieces are of annular form, outer periphery of each of which is fixed to the hat body using a stitching method.

3. The hat structure with earphones according to claim 1, wherein the earphones are installed within the earphone fixing jackets, and a fixing ring is disposed in an opening of each of the earphone fixing jackets.

4. The hat structure with earphones according to claim 3, wherein a center of the fixing ring is provided with clasp portions, which are able to fixedly clasp to an inner edge of the opening of the earphone fixing jacket.
